(19) United States
(12) Patent Application Publication
(10) Pub. No.: US 2017/0235440 A1
(43) Pub. Date: Aug. 17, 2017

(54) DISPLAY CONTROL METHOD, NON-TRANSITORY COMPUTER READABLE MEDIUM STORING DISPLAY CONTROL PROGRAM, AND TERMINAL DEVICE

(71) Applicant: FUJITSU LIMITED, Kawasaki-shi (JP)

(72) Inventor: Yoshihiko Nishida, Kawasaki (JP)

(73) Assignee: FUJITSU LIMITED, Kawasaki-shi (JP)

(21) Appl. No.: 15/367,258

(22) Filed: Dec. 2, 2016

(30) Foreign Application Priority Data
Feb. 16, 2016 (JP) 2016-027441

(51) Int. Cl. G06F 3/0482; G06F 3/0481; G06F 3/0488

(52) U.S. Cl. CPC G06F 3/0482; G06F 3/0488; G06F 3/04817; G06F 2203/04804

(57) ABSTRACT

A display control method implemented by a computer, the method includes: receiving an operation to specify an electronic file from a plurality of electronic files displayed on a screen; displaying a confirmation screen to be superposed on the screen in an opaque state in response to the reception of the operation, the confirmation screen including a first screen area and a second screen area; closing the display of the confirmation screen and performing the deletion process on the electronic file when an input to the first screen area is detected; closing the display of the confirmation screen and canceling the deletion process when an input to the second screen area is detected; and changing a display state of the confirmation screen to semitransparency while a predetermined operation to a third screen area other than the first screen area and the second screen area is detected.

### CROSS-REFERENCE TO RELATED APPLICATION

This application is based upon and claims the benefit of priority of the prior Japanese Patent Application No. 2016-027441, filed on Feb. 16, 2016, the entire contents of which are incorporated herein by reference.

### FIELD

A certain aspect of embodiments described herein relates to a display control method, a non-transitory computer readable medium storing a display control program, and a terminal device.

### BACKGROUND

There is known a dialog that presents information to a user and prompts the user for a given input, as one of Graphical User Interface (GUI) windows. For example, there is known a technique in which a user selects a deletion object from a given list and performs an input for deleting the deletion object and then a dialog for requesting the confirmation of the deletion is displayed (see Patent Document 1: Japanese Patent Application Publication No. 2001-034493). The Patent Document 1 discloses that the user inputs execution or cancel of deleting the deletion object with the use of the dialog.

Moreover, there is known a technique in which when a message window is displayed so as to be superposed on an operation button in a touch panel displaying the operation button and the message window presenting a message to an operator, a message window is changed to a semi-transmissive state (see Patent Document 2: Japanese Patent Application Publication No. 2012-083 831). The Patent Document 2 discloses that when the message window is changed to the semi-transmissive state, the operator can operate the operation button while viewing the operation button hidden by the message window.

### SUMMARY

According to an aspect of the present invention, there is provided a display control method implemented by a computer, the method including: receiving an operation to specify an electronic file of a deletion object from among a plurality of electronic files displayed on a screen; displaying a confirmation screen to be superposed on the screen in an opaque state in response to the reception of the operation, the confirmation screen including a first screen area that receives a permission input of execution of a deletion process for the electronic file and a second screen area that receives a cancel input of the deletion process; closing the display of the confirmation screen and performing the deletion process on the electronic file when an input to the first screen area is detected; closing the display of the confirmation screen and canceling the deletion process when an input to the second screen area is detected; and changing a display state of the confirmation screen to semitransparency while a predetermined operation to a third screen area other than the first screen area and the second screen area is detected.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 a diagram illustrating an example of an information processing system;

FIG. 2 is a diagram illustrating a hardware configuration of a terminal device;

FIG. 3 is a block diagram illustrating an example of the terminal device and a server;

FIG. 4 is a diagram illustrating an example of a screen operation to a display screen;

FIG. 5 is a flowchart illustrating an example of a process to be executed by the terminal device;

FIG. 6 is a diagram illustrating an example of a confirmation screen;

FIG. 7 is a diagram illustrating an example of a screen operation to the confirmation screen;

FIG. 8 is a diagram illustrating another example of the screen operation to the confirmation screen;

FIG. 9 is a diagram illustrating another example of the screen operation to the display screen;

FIG. 10 is a diagram illustrating an example of the confirmation screen changed to the semitransparency;

FIG. 11A is a diagram illustrating an example of the screen operation according to a comparative example; and

FIG. 11B is a diagram illustrating an example of the screen operation according to an embodiment.

### DESCRIPTION OF EMBODIMENTS

In Patent Document 1, when the above-mentioned dialog (hereinafter referred to as “a confirmation screen”) for requesting the confirmation is displayed on a smartphone, for example, a size of a screen of the smartphone is smaller than that of the screen of a personal computer (PC) and a ratio of the confirmation screen in the screen of the smartphone is large. The confirmation screen is often displayed at a position such as the center of the screen where the user easily notices the confirmation screen.

Therefore, there is a problem that when the above-mentioned confirmation screen to request the confirmation of the deletion is displayed, the user cannot view information about the deletion object on the screen.

Hereinafter, a description will be given of an embodiment with reference to drawings.

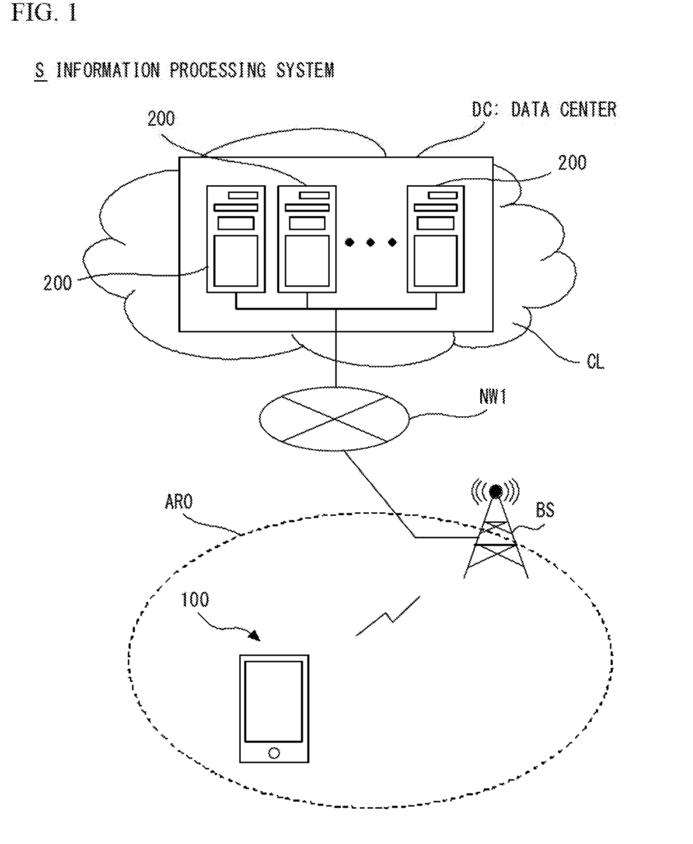

FIG. 1 a diagram illustrating an example of an information processing system S. The information processing system S includes a terminal device 100 and a server 200. FIG. 1 illustrates a smartphone as an example of the terminal device 100, but the terminal device 100 is not limited to the smartphone if it is a portable information terminal. The terminal device 100 may be a smart device such as a smart watch, a tablet terminal, a wearable computer or the like.

The terminal device 100 and the server 200 are connected to each other via a wired network NW1 and a wireless network described later. The wired network NW1 is a communication network such as an Internet, for example. The wireless network is a communication network such as a portable phone network, for example. Therefore, when the terminal device 100 is included in an area AR0 enabling a wireless communication, the terminal device 100 can communicate with the server 200.

The terminal device 100 receives various information transmitted from the server 200 and transmits various information to the server 200. When the terminal device 100 transmits a browsing request for requesting browsing of an electronic file to the server 200 storing a plurality of electronic files, for example, the server 200 receives the browsing request.

More particularly, a base station BS receives the browsing request transmitted from the terminal device 100 via the wireless network. The base station BS transfers the received browsing request to the server 200. The server 200 receives the browsing request transferred by the base station BS via the wired network NW1. When the server 200 receives the browsing request, the server 200 permits the terminal device 100 to browse the electronic file. When the server 200 receives the browsing request, the server 200 may transmit a list of the electronic files and each corresponding electronic file to the terminal device 100 in accordance with the browsing request.

Moreover, the terminal device 100 may transmit a deletion request for requesting the deletion of the electronic file. In this case, the server 200 deletes the electronic file in accordance with the deletion request.

The above-mentioned electronic files include program files, data files and the like, for example. The data files include a document file, an image file such as a moving image and a still image, a sound file, an E-mail and the like, for example. In FIG. 1, the server 200 is provided in a data center DC on a cloud CL. For example, when the base station BS is changed to an access point and a local area network (LAN) is used as the wired network NW1, the server 200 may be connected to the LAN.

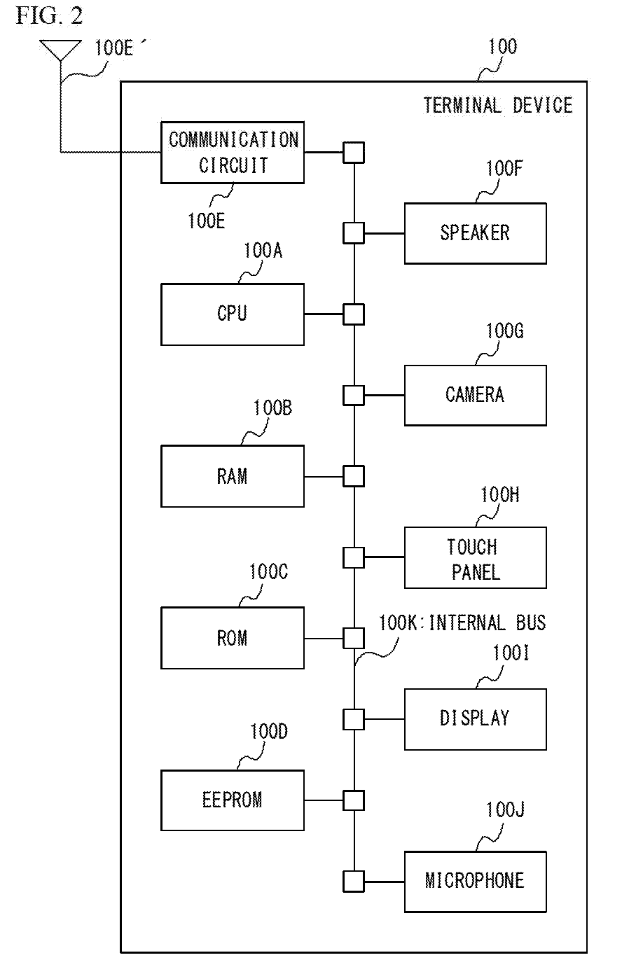

Next, a description will be given of a hardware configuration of the terminal device 100 with reference to FIG. 2. Here, the above-mentioned server 200 basically has the same configuration as the terminal device 100, and a description thereof is therefore omitted.

FIG. 2 is a diagram illustrating the hardware configuration of the terminal device 100. As illustrated in FIG. 2, the terminal device 100 includes a Central

Processing Unit (CPU) 100A, a Random Access Memory (RAM) 100B, a Read Only Memory (ROM) 100C, an Electrically Erasable Programmable Read Only Memory (EEPROM) 100D and a communication circuit 100E. An antenna 100E′ is connected to the communication circuit 100E. A CPU that achieves a communication function may be used as substitute for the communication circuit 100E.

Moreover, the terminal device 100 includes a speaker 100F, a camera 100G, a touch panel 100H, a display 100I and a microphone 100J. The camera 100G includes an imaging element using a Complementary Metal Oxide Semiconductor (CMOS) or a Charge Coupled Device (CCD), and an optical system such as a lens. The CPU 100A to the microphone 100J are connected to each other via an internal bus 100K. At least the CPU 100A and the RAM 100B cooperate with each other, so that a computer is achieved.

A program stored into the ROM 100C or the EEPROM 100D is stored into the above-mentioned RAM 100B by the CPU 100A. The CPU 100A executes the stored program, so that various functions described later are achieved and various processes are performed. Here, the program needs to correspond to a flowchart described later.

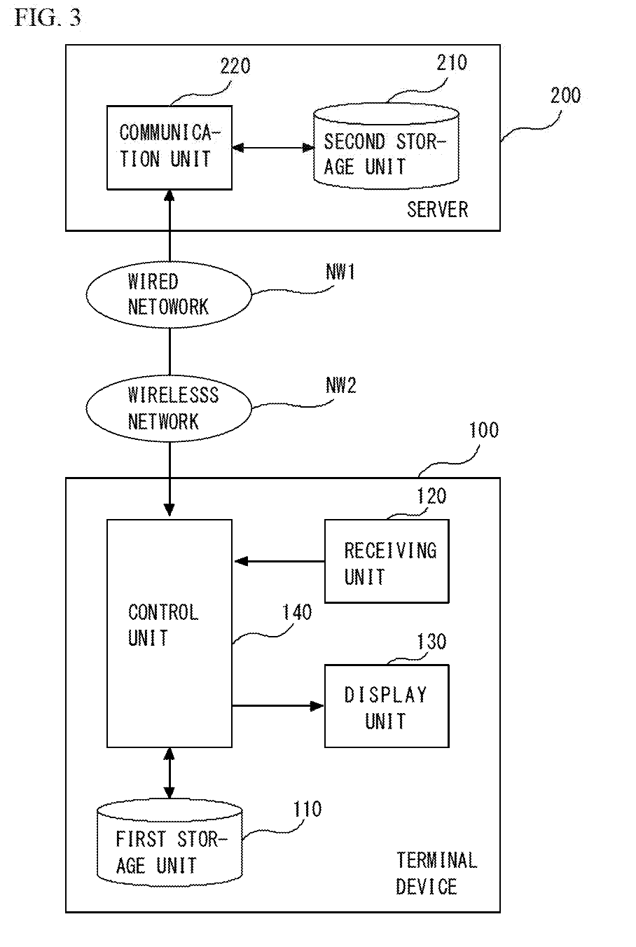

Next, a description will be given of each function of the terminal device 100 and the server 200 with reference to FIG. 3.

FIG. 3 is a block diagram illustrating an example of the terminal device 100 and the server 200. The terminal device 100 includes a first storage unit 110, a receiving unit 120, a display unit 130 and a control unit 140. The server 200 includes a second storage unit 210 and a communication unit 220. First, a description will be given of the terminal device 100, and next a description will be given of the server 200.

The first storage unit 110 stores the plurality of electronic files. As described above, the electronic files include program files, data files and the like, for example. The data files include the document file, the image file such as the moving image and the still image, the sound file, the E-mail and the like, for example. The first storage unit 110 stores the E-mail received via the above-mentioned communication circuit 100E, for example. The first storage unit 110 stores the moving image or the still image captured by the above-mentioned camera 100G as the image file, for example. The first storage unit 110 stores a sound acquired from the above-mentioned microphone 100J as the sound file, for example. Here, the first storage unit 110 corresponds to the above-mentioned EEPROM 100D or the like, for example.

The receiving unit 120 receives an operation which specifies an electronic file of a deletion object from among the plurality of electronic file displayed on the display screen of the terminal device 100. Here, the receiving unit 120 corresponds to the above-mentioned touch panel 100H or the like, for example.

The display unit 130 displays a confirmation screen superposed on the display screen of the terminal device 100 in an opaque state when the receiving unit 120 has received the operation which specifies the electronic file. The confirmation screen includes a first screen area (hereinafter simply referred to as “a first area”) and a second screen area (hereinafter simply referred to as “a second area”) as operation parts, along with a confirmation message. The first area receives a permission input of execution of a deletion process for the electronic file of the deletion object. The second area receives a cancel input of the deletion process for the electronic file of the deletion object. An instruction is included in these input. A user can select any one of the first area and the second area. The display unit 130 corresponds to the above-mentioned display 100I or the like, for example.

When the control unit 140 detects an input to the first area in the confirmation screen, the control unit 140 closes the display of the confirmation screen and performs the deletion process on the electronic file. The electronic file that is an object of the deletion process may be stored into the first storage unit 110 or the second storage unit 210. When the control unit 140 detects an input to the second area in the confirmation screen, the control unit 140 closes the display of the confirmation screen and cancels the deletion process. While detecting a given operation to a third area in the confirmation screen different from the first area and the second area, the control unit 140 controls a transmittancy of at least a part of the confirmation screen so as to be higher than a transmittancy before the operation. The control unit 140 changes a display state of the confirmation screen to semitransparency, for example. More specifically, the control unit 140 changes a transmittancy of a background color of the confirmation screen to a transmittancy in which the information in the screen hidden by the superposition of the confirmation screen can be viewed.

Here, in response to an operation for an area in the display screen outside the confirmation screen, the control unit 140 may control the transmittancy of at least the part of the confirmation screen so as to be higher than the transmittancy before the operation. Moreover, the control unit 140 controls the transmittancy of at least the part of the confirmation screen so as to be higher than the transmittancy before the operation, and then the control unit 140 further control at least one of the first area and the second area to be operable. The control unit 140 corresponds to the CPU 100A, the RAM 100B and the communication circuit 100E or the like, for example. The given operation is a touch operation or the like, for example.

The second storage unit 210 stores a plurality of electronic files. The contents of the electronic files are basically the same as those of the electronic files stored into the first storage unit 110. The second storage unit 210 stores the E-mail in addition to the document file, the image file and so on transmitted via the communication circuit 100E, for example. Here, the second storage unit 210 corresponds to a Hard Disk Drive (HDD) or the like, for example.

The communication unit 220 communicates with the control unit 140. When the above-mentioned browsing request is transmitted from the control unit 140, for example, the communication unit 220 receives the browsing request by way of the wireless network NW2 and the wired network NW1. When the communication unit 220 receives the browsing request, the communication unit 220 permits the terminal device 100 to browse the electronic files stored into the second storage unit 210. When the above-mentioned deletion request is transmitted from the control unit 140, for example, the communication unit 220 receives the deletion request by way of the wireless network NW2 and the wired network NW1. When the communication unit 220 receives the deletion request, the communication unit 220 deletes the electronic file corresponding to the deletion request from the electronic files stored into the second storage unit 210. When the communication unit 220 receives an acquisition request of the electronic file from the control unit 140, the communication unit 220 extracts the electronic file corresponding to the acquisition request from the second storage unit 210 and transmits the extracted electronic file to the control unit 140. The communication unit 220 corresponds to a CPU, a RAM, a communication circuit and so on included in the server 200, for example.

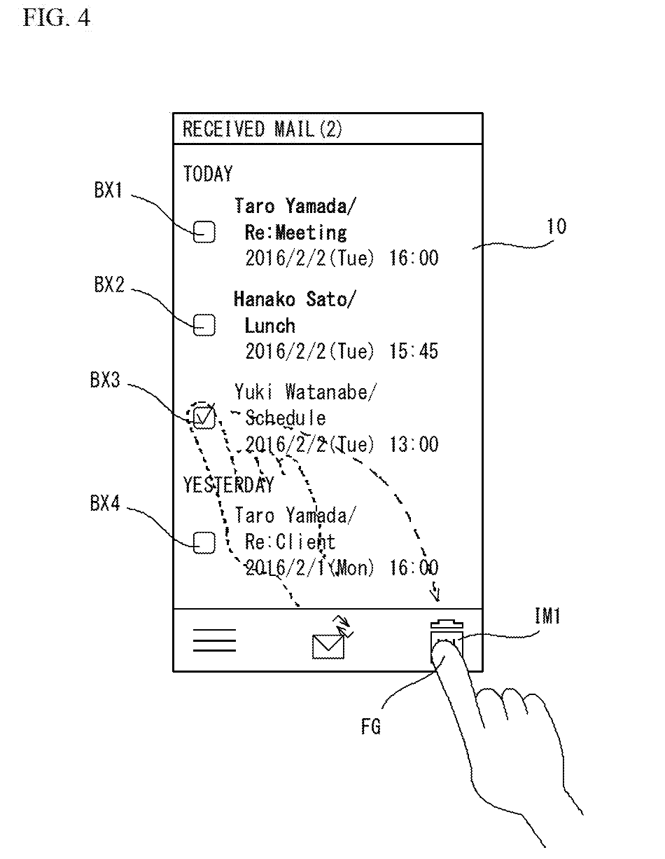

Next, a description will be given of the actuation of the terminal device 100 with reference to FIGS. 4 to 10.

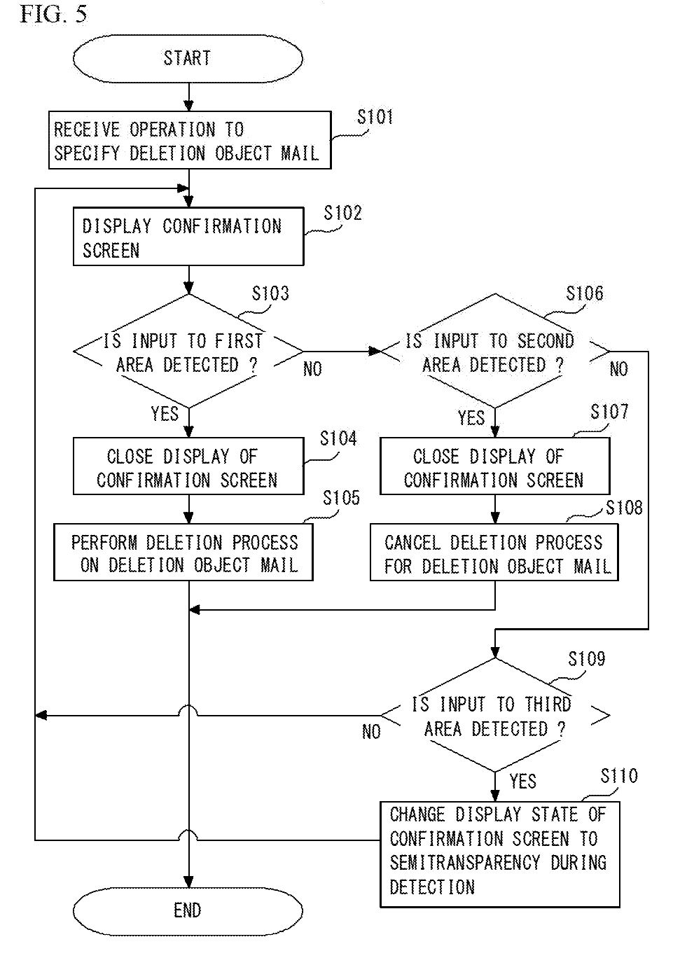

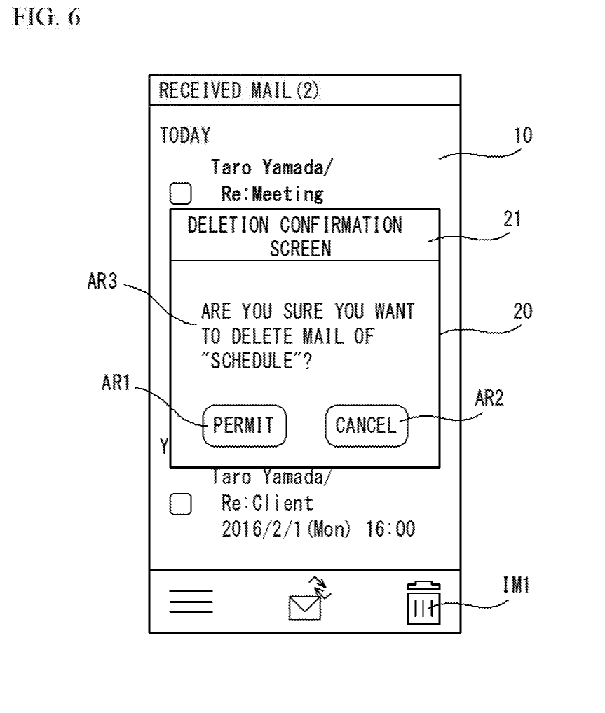

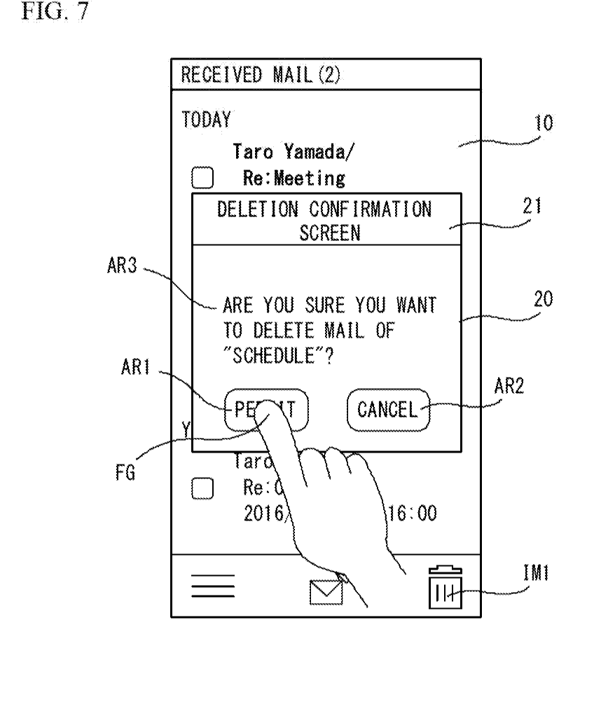

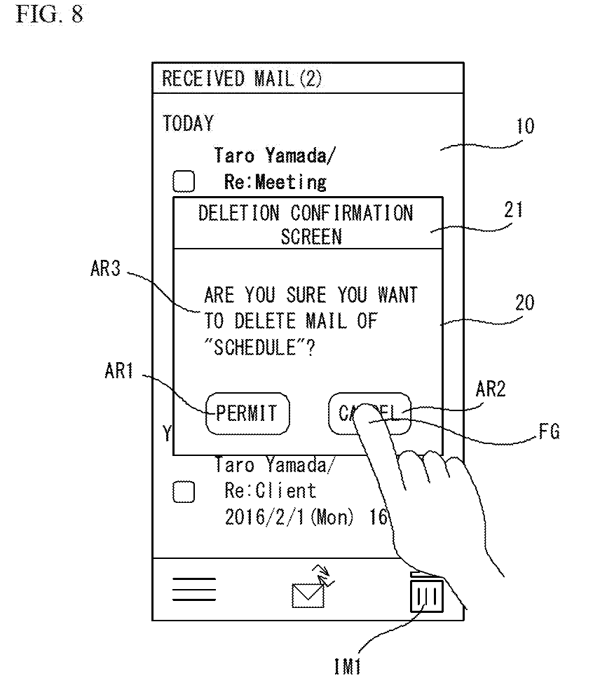

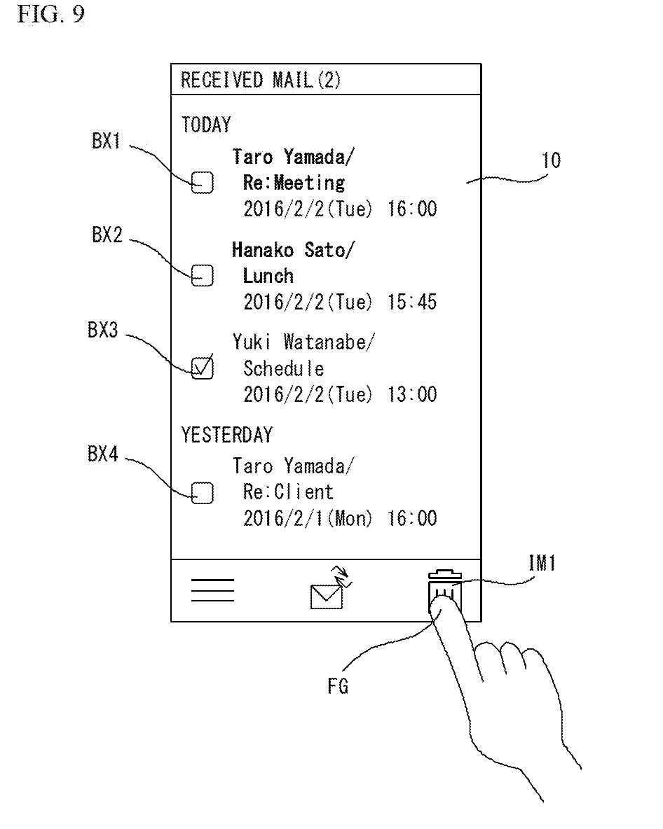

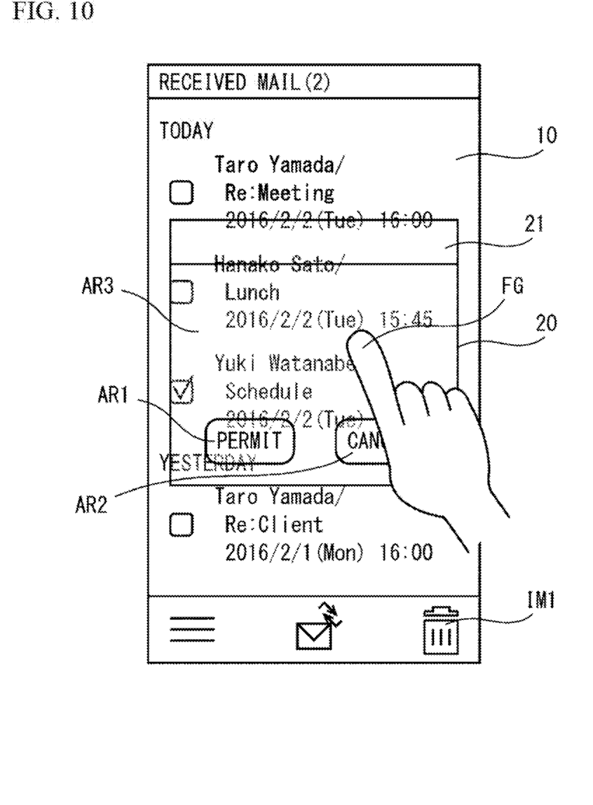

FIG. 4 is a diagram illustrating an example of a screen operation to a display screen 10. FIG. 5 is a flowchart illustrating an example of a process to be executed by the terminal device 100. FIG. 6 is a diagram illustrating an example of a confirmation screen 20. FIG. 7 is a diagram illustrating an example of the screen operation to the confirmation screen 20. FIG. 8 is a diagram illustrating another example of the screen operation to the confirmation screen 20. FIG. 9 is a diagram illustrating another example of the screen operation to the display screen 10. FIG. 10 is a diagram illustrating an example of the confirmation screen 20 changed to the semitransparency.

Hereinafter, a description will be given of the deletion process of an E-mail stored into a reception box (or a reception tray) as an example. As long as the deletion object is the electronic file, the deletion object is not limited to the E-mail. A plurality of document files and image files stored into an electronic folder may become the deletion object, for example.

The user performs an operation to run mail software on the receiving unit 120. The mail software is application software for creating and transmitting the

E-mail, and managing the received E-mail. The application software is also called “mailer”, for example. When the receiving unit 120 receives the operation from the user, the control unit 140 runs the mail software, and controls the display unit 130 so as to display the display screen 10 for displaying the E-mail. Thereby, the display unit 130 displays the display screen 10 indicative of a list of received E-mails, as illustrated in FIG. 4.

The display screen 10 includes a plurality of e-mails as display objects, a plurality of check boxes BX1 to BX4 associated with the respective E-mails, an operable image IM1 for requesting the execution of the deletion, and so on. Each of the check boxes BX1 to BX4 is an input field for specifying the E-mail of the deletion object by check.

Here, when the receiving unit 120 receives an operation to specify the E-mail of the deletion object (hereinafter referred to as “a deletion object mail”) (step S101) as illustrated in FIG. 5, the display unit 130 displays the confirmation screen 20 (step S102). More specifically, when the receiving unit 120 receives the operation to specify the deletion object mail, the control unit 140 controls the display unit 130 so as to display the confirmation screen 20 and the display unit 130 displays the confirmation screen 20.

When the user performs a tap operation which taps the check box BX3 by a finger FG as illustrated in FIG. 4, for example, the receiving unit 120 receives the tap operation as an operation to specify an E-mail associated with the check box BX3. Thereby, the display unit 130 displays a check on the check box BX3. Then, when the user performs the tap operation on the image IM1 by the finger FG to request the execution of the deletion as illustrated in FIG. 4, the receiving unit 120 receives the tap operation. Hereby, the control unit 140 controls the display unit 130 so as to display the confirmation screen 20 and the display unit 130 displays the confirmation screen 20 as illustrated in FIG. 6.

The confirmation screen 20 includes the first area AR1, the second area AR2 and the third area AR3 mentioned above. The first area AR1 includes a character “PERMIT”. The second area AR2 includes a character “CANCEL”. The third area AR3 includes a confirmation message “ARE YOU SURE YOU WANT TO DELETE MAIL OF “SCHEDULE”?”. The third area AR3 may or may not include a title part 21 of the confirmation screen 20. The display unit 130 displays the confirmation screen 20 in the opaque state as illustrated in FIG. 6, and therefore a part of the display screen 10 is hidden by the confirmation screen 20. Thus, with respect to the part of the display screen 10 hidden by the confirmation screen 20, the user cannot view detailed information about the E-mails.

Here, when the user performs the tap operation on the first area AR1 by the finger FG as illustrated in FIG. 7, the control unit 140 detects an input to the first area AR1 (YES in step S103) and the display unit 130 closes the display of the confirmation screen 20 (step S104), as illustrated in FIG. 5. When the process of step S104 is completed, the control unit 140 performs the deletion process on the deletion object mail (step S105). More specifically, the control unit 140 deletes the E-mail as the deletion object specified by the check box BX3 from the first storage unit 110 or the second storage unit 210.

On the other hand, when the user performs the tap operation on the second area AR2 by the finger FG as illustrated in FIG. 8, the control unit 140 does not detect the input to the first area AR1 (NO in step S103) but detects the input to the second area AR2 (YES in step S106).

Even when there are a plurality of E-mails having a subject “SCHEDULE” for example, and the user wants to delete the E-mail received at a specific time therefrom, a reception time is not included in the confirmation screen 20. Therefore, it is assumed that, to reconfirm the reception time, the user performs the tap operation on the second area AR2 and the display of the confirmation screen 20 is closed. Also when the user wants to delete the E-mail transmitted by a specific sender, the same process is assumed. That is, it is assumed that, when the user carefully determines whether the deletion object E-mail is erroneously specified, the user performs the tap operation on the second area AR2.

When the control unit 140 detects the input to the second area AR2 at step S106, the display unit 130 closes the display of the confirmation screen 20 (step S107), the control unit 140 cancels the deletion process for the deletion object mail (step S108). Therefore, the display unit 130 displays the display screen 10 including the check box BX3 to which the check has been input, as illustrated in FIG. 9.

Thereby, when the deletion object E-mail is erroneously specified, the user performs the tap operation on the check box BX3 again to uncheck the check box BX3, and performs the tap operation on the check box BX2 to check the check box BX2. After the check has been input to the check box BX3 or when the deletion object E-mail is correct, the user performs the tap operation on the image IM1 by the finger FG to request the execution of the deletion as illustrated in FIG. 9. Hereby, the above-mentioned process of steps S101 and S102 is performed. Therefore, the display unit 130 displays the confirmation screen 20 again (see FIG. 6).

On the contrary, in the present embodiment, when the user performs a touch operation on the third area AR3 by the finger FG as illustrated in FIG. 10, the control unit 140 does not detect the input to the second area AR2 (NO in step S106) but detects the touch operation to the third area AR3 (YES in step S109), as illustrated in FIG. 5.

When the control unit 140 detects the touch operation at step S109, the control unit 140 changes the display state of the confirmation screen 20 to the semitransparency while detecting the touch operation, as illustrated in FIG. 10 (step S110). When the control unit 140 changes the display state of the confirmation screen 20 to the semitransparency, the control unit 140 further may stop displaying the message in the third area AR3. In this case, the control unit 140 may stop or continue displaying the characters in the first area AR1 and the second area AR2. While detecting the touch operation, the control unit 140 may control the E-mail and the check boxes BX1 to BX4 so as to be inoperable or operable.

Therefore, when there are the plurality of E-mails having the subject “SCHEDULE” and the user wants to delete the E-mail received at the specific time therefrom, the user can confirm the reception time while the finger FG of the user is touching the third area AR3. Also when the user wants to delete the E-mail transmitted by a specific sender, the user can confirm the specific sender while the finger FG of the user is touching the third area AR3. That is, even when the user carefully determines whether the deletion object E-mail is erroneously specified, the user can confirm the information in the display screen 10 hidden by the confirmation screen 20 by only keeping the touch operation to the third area AR3.

When the control unit 140 does not detect the touch operation to the third area AR3 (NO in step S109) or the process of step S110 is completed, the procedure returns to step S102. Thereby, the display unit 130 displays the confirmation screen 20 in the opaque state. Therefore, the user can input the permission or the cancel of deletion of the deletion object E-mail by selecting any one of the first area AR1 or the second area AR2.

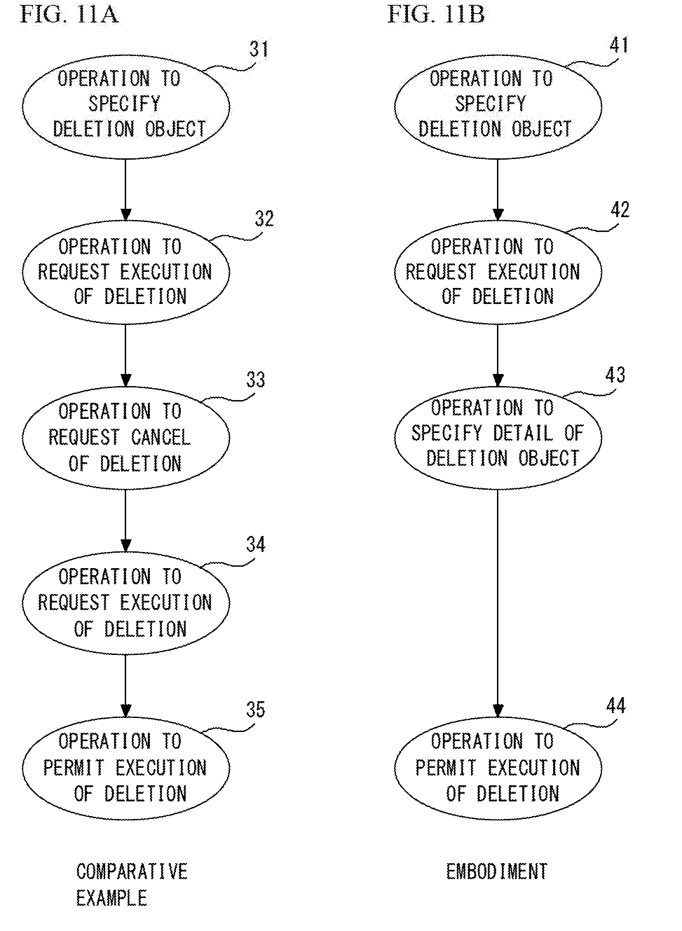

Next, a description will be given of an embodiment by contrast with a comparative example, with reference to FIGS. 11A and 11B.

FIG. 11A is a diagram illustrating an example of the screen operation according to the comparative example. FIG. 11B is a diagram illustrating an example of the screen operation according to the embodiment. First, as illustrated in FIG. 11A, the user performs an operation 31 to specify the deletion object, and then performs an operation 32 to request the execution of the deletion. Specifically, the user checks the check box BX3 of the E-mail which is the deletion object by the tap operation, and performs the tap operation on the image IM1, as explained with reference to FIG. 4. Thereby, the display unit 130 displays the confirmation screen 20 as illustrated in FIG. 6.

Next, the user performs an operation 33 to request the cancel of the deletion in order to confirm the detailed information on the deletion object mail as illustrated in FIG. 11A. Specifically, the user performs the tap operation on the second area AR2 as illustrated in FIG. 8. Thereby, the display unit 130 closes the display of the confirmation screen 20. As a result, the whole of the display screen 10 appears as illustrated in FIG. 9.

When the user confirms the detailed information on the deletion object mail and determines that the operations 31 and 32 are not wrong, the user performs an operation 34 to request the execution of the deletion again as illustrated in FIG. 11A.

Specifically, the user performs the tap operation on the image IM1 as illustrated in FIG. 9. Thereby, the display unit 130 displays the confirmation screen 20 again as illustrated in FIG. 6. Finally, the user performs an operation 35 to permit the execution of the deletion. Specifically, the user performs the tap operation on the first area AR1 as illustrated in FIG. 7. Thereby, the display unit 130 closes the display of the confirmation screen 20 and the control unit 140 deletes the E-mail which is the deletion object. Thus, when the user carefully performs the operation to delete the E-mail, five operations may be performed.

Contrastively, in the embodiment, the user performs an operation 41 to specify the deletion object, and then performs an operation 42 to request the execution of the deletion. That is, the operations 41 and 42 are the same as the operations 31 and 32 explained in the comparative example. Thereby, the display unit 130 displays the confirmation screen 20. Next, the user performs an operation 43 to specify the detail of the E-mail. Specifically, the user performs the touch operation on the third area AR3 as illustrated in FIG. 10. Thereby, the control unit 140 changes the display state of the confirmation screen 20 to the semitransparency. As a result, the user can view the detailed information in the display screen hidden by the confirmation screen 20.

When the user confirms the detailed information on the E-mail and determines that the operations 41 and 42 are not wrong, the user performs an operation 44 to permit the execution of the deletion as illustrated in FIG. 11B. Specifically, the user releases the finger FG from the third area AR3 and performs the tap operation on the first area AR1 as illustrated in FIG. 7. Thereby, the display unit 130 closes the display of the confirmation screen 20 and the control unit 140 deletes the E-mail which is the deletion object. Thus, even when the user carefully performs the operation to delete the E-mail, only four operations are enough as a whole, which can reduce the operation number of times in contrast to the comparative example.

According to the present embodiment, the terminal device 100 includes the receiving unit 120, the display unit 130 and the control unit 140. The receiving unit 120 receives the operation to specify the electronic file of the deletion object from among the plurality of electronic files displayed on the display screen 10. The display unit 130 displays the confirmation screen 20 so as to be superposed on the display screen 10 in response to the reception of the specifying operation. When the control unit 140 detects the input to the first area AR1 in the confirmation screen 20, the control unit 140 closes the display of the confirmation screen 20 and performs the deletion process on the electronic file. When the control unit 140 detects the input to the second area AR2 in the confirmation screen 20, the control unit 140 closes the display of the confirmation screen 20 and cancels the deletion process. The control unit 140 changes the display state of the confirmation screen 20 to the semitransparency while detecting the touch operation to the third area AR3 in the confirmation screen 20. Thereby, it is possible to control screen display so as to be capable of viewing the information about the electronic file of the deletion object in the display screen 10 hidden by the superposition of the confirmation screen 20 without moving the confirmation screen 20.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A display control method implemented by a computer, the method comprising:
receiving an operation to specify an electronic file of a deletion object from among a plurality of electronic files displayed on a screen;
displaying a confirmation screen to be superposed on the screen in an opaque state in response to the reception of the operation, the confirmation screen including a first screen area that receives a permission input of execution of a deletion process for the electronic file and a second screen area that receives a cancel input of the deletion process;
closing the display of the confirmation screen and performing the deletion process on the electronic file when an input to the first screen area is detected;
closing the display of the confirmation screen and canceling the deletion process when an input to the second screen area is detected; and
changing a display state of the confirmation screen to semitransparency while a predetermined operation to a third screen area other than the first screen area and the second screen area is detected.

2. The display control method of claim 1, wherein
the predetermined operation is a touch operation to the third screen area in the confirmation screen.

3. The display control method of claim 1, wherein
the changing includes changing a transmittancy of a background color of the confirmation screen to a transmittancy in which information in the screen hidden by the superposition of the confirmation screen is visible.

4. A non-transitory computer readable medium storing a display control program, the program causing a computer to execute a process, the process comprising:
receiving an operation to specify an electronic file of a deletion object from among a plurality of electronic files displayed on a screen;
displaying a confirmation screen to be superposed on the screen in an opaque state in response to the reception of the operation, the confirmation screen including a first screen area that receives a permission input of execution of a deletion process for the electronic file and a second screen area that receives a cancel input of the deletion process;
closing the display of the confirmation screen and performing the deletion process on the electronic file when an input to the first screen area is detected;
closing the display of the confirmation screen and canceling the deletion process when an input to the second screen area is detected; and
changing a display state of the confirmation screen to semitransparency while a predetermined operation to a third screen area other than the first screen area and the second screen area is detected.

5. A terminal device, comprising:
a receiver configured to receive an operation to specify an electronic file of a deletion object from among a plurality of electronic files displayed on a screen;
a display configured to display a confirmation screen to be superposed on the screen in an opaque state in response to the reception of the operation, the confirmation screen including a first screen area that receives a permission input of execution of a deletion process for the electronic file and a second screen area that receives a cancel input of the deletion process; and
a controller configured to close the display of the confirmation screen and performing the deletion process on the electronic file when an input to the first screen area is detected, close the display of the confirmation screen and canceling the deletion process when an input to the second screen area is detected, and change a display state of the confirmation screen to semitransparency while a predetermined operation to a third screen area other than the first screen area and the second screen area is detected.

6. The terminal device of claim 5, wherein
the predetermined operation is a touch operation to the third screen area in the confirmation screen.

7. The terminal device of claim 5, wherein
the controller changes a transmittancy of a background color of the confirmation screen to a transmittancy in which information in the screen hidden by the superposition of the confirmation screen is visible.
